(19) United States
(12) Patent Application Publication
(10) Pub. No.: US 2010/0167704 A1
(43) Pub. Date: Jul. 1, 2010

(54) SYSTEM FOR MANAGING VISUAL INFORMATION

(76) Inventor: Jay Villemaire, Macomb Township, MI (US)

Correspondence Address: HARNESS, DICKEY & PIERCE, P.L.C., P.O. BOX 828, BLOOMFIELD HILLS, MI, 48303, US

(21) Appl. No.: 12/491,479

(22) Filed: Jun. 25, 2009

Related U.S. Application Data
(60) Provisional application No. 61/075,561, filed on Jun. 25, 2008.

(51) Int. Cl. H04M 3/42; H04Q 5/22

(52) U.S. Cl. 455/414.1; 340/10.1

(57) ABSTRACT

Systems and methods for managing, ordering, designing, tracking, and displaying visual information, such as advertisements displayed on waste and recycling containers. Visual information includes one or a multitude of media displays or advertisements. A container tracking and identification system communicates with a management system to provide the user with a method and system for ordering, managing, tracking, and displaying visual information for targeted consumer viewing on the containers.

### CROSS-REFERENCE TO RELATED APPLICATIONS

This application claims the benefit of U.S. Provisional Application No. 61/075,561, filed on Jun. 25, 2008. The entire disclosure of the above application is incorporated herein by reference.

### FIELD

The present disclosure relates to systems and methods for managing, ordering, designing, tracking, and displaying visual information, where the visual information may include advertising.

### INTRODUCTION

Costs associated with the infrastructure of waste and recycling collection steadily increases. In today's model, the burden of rising costs is placed on residents by either increasing their tax dollars or out-of-pocket expenses. As Corporate Social Responsibility continues to dominate the headlines, businesses are heavily investing on improving their product lifecycle environmental impact. Up to this point, business initiatives have mainly focused on creating environmentally friendly products and packaging, ultimately leaving costs associated with the disposal of products and packaging to remain with consumers and communities. There is a need for businesses to be responsible and invest in the infrastructure that supports long-term disposal of their products. Likewise, the advertisement industry continues to pursue better ways of tracking the effectiveness of advertisement as well as the level of intimacy that can be gained with consumers.

A large amount of recyclable material is unsorted and instead directed into general waste, where it ends up in landfills. This unclaimed recyclable material is lost to municipalities, residential areas, businesses, and manufactures who could derive value from the reclaimed material. In addition, the added burden on landfills can actually increase costs to a community. Present infrastructure of waste and recycling collection fails to provide adequate incentives for communities to adopt and maintain recycling programs. There is a need for improved methods and systems for increasing participation in recycling and for managing incentives to recruit and maintain recycling efforts.

The statements in this section merely provide background information related to the present disclosure and may not constitute prior art.

### SUMMARY

The present disclosure includes systems and methods related to managing visual information on an object, such as one or more waste and recycling containers. The systems and methods include a management system that is accessed by a user and can be modified by a program manager. The management system sends and receives information from a tracking system and sends and receives information about a container displaying visual information. The tracking system monitors the container displaying visual information. The methods and systems may be used to manage value relating to the visual information displayed on the container. The value may include incentives, rewards, or donations that are accounted and distributed via the management system to the user or another entity, such as a charity.

A system for managing visual information observable by a viewer can include the following components. An object displays visual information observable by the viewer and includes a tracking function. A mobile device operates to interact with the tracking function of the object and a tracking system operates to register interaction of the mobile device with the tracking function. A management system has at least one rule governing interaction of the mobile device with the tracking function and operation of the tracking system, where the rule(s) operates to award a value based on interaction of the mobile device with the tracking function and operation of the tracking system. A rewards entity receives the value awarded by the rule(s) of the management system and provides a return value to a user, such as the viewer.

In some cases, the present systems and methods provide for the following aspects. The object displaying visual information observable by the viewer may be a recycling container and the mobile device may be comprised by a recycling collection vehicle. The user that is provided the return value may be a residential waste customer.

In other embodiments, the user that is provided the return value is the viewer. The mobile device may be a cell phone and/or may be operable to passively interact with the tracking function of the object and/or operable to actively interact with the tracking function of the object via action of the viewer. The tracking function may be an RFID tag, bar code, or electronic wireless transmitter. The system may further comprise a managing entity that provides at least one rule to the managing system. The managing entity and/or the rewards entity may each be a governmental entity, a commercial retailer or manufacturer, and/or benefactor, and in some embodiments the managing entity and the rewards entity may be the same entity. The return value provided to the user or viewer may be in the form of a monetary return, discount, coupon, credit, miles, or points.

Further areas of applicability will become apparent from the description provided herein. It should be understood that the description and specific examples are intended for purposes of illustration only and are not intended to limit the scope of the present disclosure.

### DRAWINGS

FIG. 1 is a block diagram of one embodiment of a system for managing visual information on a container constructed according to the present disclosure;

FIG. 2 is a block diagram of another embodiment of a system for managing visual information on a container constructed according to the present disclosure;

FIGS. 3A and 3B illustrate two embodiments of containers displaying visual information;

FIG. 4 is a block diagram of one embodiment of a system for managing visual information illustrating interaction of a viewer with the system;

FIG. 5 is a block diagram of another embodiment of a system for managing visual information illustrating interaction of a viewer with the system;

FIG. 6 is a block diagram of another embodiment of a system for managing visual information illustrating interaction of a viewer with the system; and

FIG. 7 is a block diagram of another embodiment of a system for managing visual information illustrating interaction of a viewer with the system.

The drawings described herein are for illustration purposes only and are not intended to limit the scope of the present disclosure in any way.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

In some embodiments, the present disclosure provides systems and methods for managing visual information displayed on an object, such as waste and recycling containers. The system includes management means that is modifiable by a program manager. The management means is accessed by one or more users so the user can select visual information to be displayed on a container. The management means communicates with a tracking means, where the tracking means monitors the container displaying the visual information. The management means directs what visual information is displayed on the container in response to a selection by the user. Alternatively or in addition to, the tracking means may further include delivery means for providing the container displaying visual information selected by the user and/or may deliver or exchange the visual information displayed on a preexisting container.

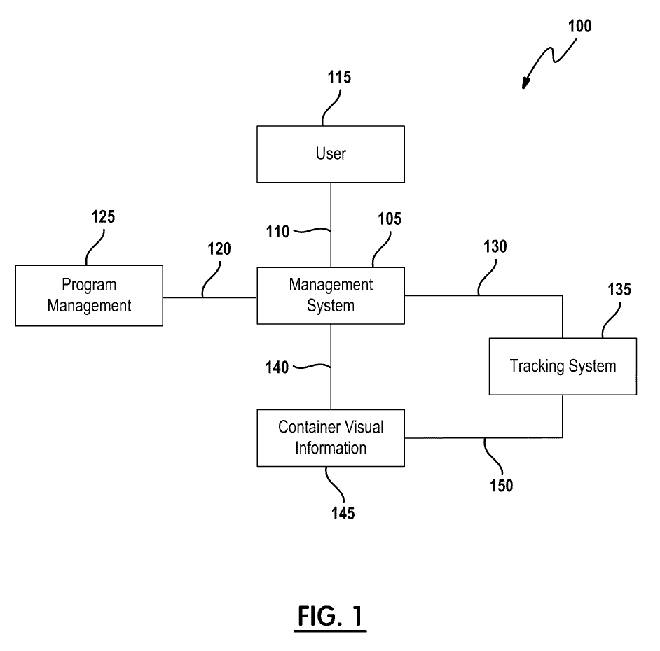

With reference to FIG. 1, a block diagram is shown for one embodiment of a system 100 for managing visual information displayed on waste and recycling containers. A management system 105, such as a website, is accessible 110 to at least one user 115, such as a residential waste customer. The management system 105 is modifiable and controllable 120 by a program manager 125, which may be a local governmental entity for example. The management system 105 also communicates 130 with a tracking system 135. The user 115 accesses 110 the management system 105 to select and configure a container displaying visual information 145 and the management system 105 directs 140 delivery of the selected container 145 to the user 115. Alternatively, or in addition to, the tracking system 135 may further include the ability to deliver the selected container 145 to the user 115. For example, the tracking system may be part of a waste and recycling collection system, including a collection vehicle, which can deliver, pick up, or exchange the container displaying visual information 145, or just the visual information may be added to or exchanged on the container, based on user 115 selections made using the management system 105. For example, the visual information may be an integral part of the container or may be part of a display that is permanently or removably affixed to the container. Therefore, just the visual information and not the whole container may be delivered, picked up, or exchanged as directed by the management system 105.

In some embodiments, the present disclosure provides methods and systems for managing visual information and value associated with the visual information. The methods and systems allow a residential consumer to choose a container type and visual information, such as an advertisement, for display on the container by using a management system. The management system is modifiable and controllable by a program manager, such as a governmental entity. Other users can communicate with the management system, including advertising clients, causes or benefactors such as charities, and waste collection, management, and recycling entities.

The management system accounts for, assigns, and distributes value related to the container and/or visual information displayed on the container, where the value is based on the selections made by the residential consumer in view of options and value assignments provided. The other users, including advertising clients, causes and benefactors, governmental entities, and the waste collection service can receive information from the management system based on the residential consumer selections and can provide information to the management system. For example, these other users can modify or assign value to particular selections in the management system available to the residential consumer. The management system then directs the manufacture or delivery of the container displaying visual information or a display of visual information to be affixed to a preexisting container. The container and/or display is shipped and tracked to the residential consumer.

The residential consumer uses the container displaying visual information for depositing waste and recyclable materials that are received by a waste collection infrastructure. The waste collection infrastructure includes one or more collection vehicles and includes a tracking system. The tracking system records one or more metrics relating to waste and recyclable material collected, instances and durations relating to the display of the visual information, identity of the visual information, and the type and location of the container. The one or more metrics recorded by the tracking system are communicated to the management system where all or a portion of the data is accessible by the various users.

The management system manages the value assigned to containers and visual information. Management of value includes modifying value based on the one or more metrics received via the tracking system and waste collection infrastructure. Value may include returns such as incentives, rewards, or donations that are accounted and distributed via the management system to the residential consumer or other user and may have monetary value. For example, the system can be configured so that costs of the containers, visual information displays, and waste collection infrastructure are managed as a nonprofit or as a for-profit system. Value can be exchanged between the residential consumer and other users to provide incentives for waste and recycling collection. Value may also accrue based on the amount of recyclable material collected, visibility, and/or frequency or instances of each, by the waste collection infrastructure, which can even be tracked to a particular user by the tracking system installed on the collection vehicle.

As one example, the method and system may operate as follows. The residential consumer accesses a website based management system to select a particular sized container and further selects a particular advertisement display to accompany the container. The residential consumer further apportions some or all value associated with the visual information display to one or more entities. The choices of available containers and advertisement displays on the website management system are categorized by the local governmental entity and/or local waste or container management company acting as the program manager. These container and display choices are assembled from options provided by advertising clients, which are modified and filtered by the local governmental entity. For example, users in business districts may be allowed to select alcohol or tobacco advertising but program management by the local governmental entity may prevent residential consumers from selecting such advertising.

The container and/or visual information display is delivered to the residential consumer by a collection vehicle having a tracking system or by another means, such as mail, and applied to the container by the residential consumer. Over the next several weeks, the collection vehicle picks up waste and/or recyclables from the container and tracks the instances, time, and location of the container and advertisement display. These metrics are sent to the website management system where the management system then collects and allots value and return value between the various users. For example, if the tracking system records that the container and visual information display are observed ten times over a twelve week collection interval, the management system credits the residential consumer based on the number of display instances. Accordingly, the management system collects revenue from the particular advertising client. The revenue is dispensed according to the local governmental entity settings and selections by the residential consumer. For example, a percentage of revenue is allotted to a charity selected by the residential consumer, a percentage is allotted to offset the cost of waste/recycling collection by the governmental entity, and a percentage is allotted to offset the manufacturing costs of the container and/or advertisement display.

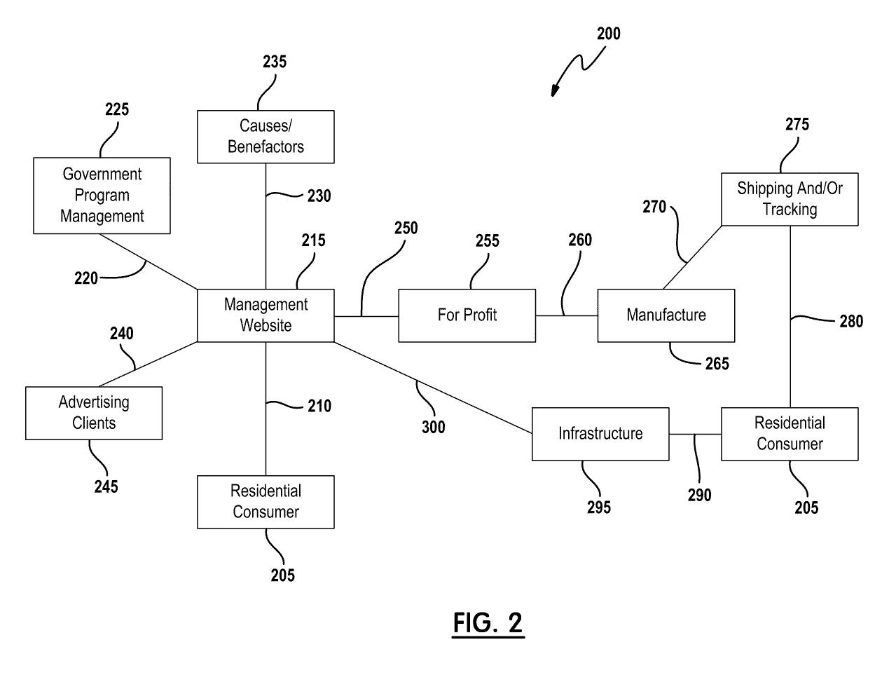

With reference to FIG. 2, a block diagram of a system 200 for managing visual information and value associated with the visual information is shown. A residential consumer 205 accesses 210 a management website 215 to select a container and visual information to be displayed on the container. Various containers and displays of visual information are assigned various values. For example, the size of the displayed visual information may be related to the size of the container and may further be related to value assigned to the container and display combination; e.g., larger displays correlate with greater value. As another example, value may change in respect to the size of the visual information displayed, the size of the container, and the content of the visual information. In yet another example, an advertising client such as a soft drink manufacturer may assign particular values for different soft drink advertisement selections, including different advertising campaigns, while an advertising client such as a retailer may assign values for particular advertisement selections and even color selections of the container.

The management website 215 is connected 220 to a government program 225. The government program 225 allows one or more government officials to manage and modify the management website profile, management preferences, censorship filters, end user settings, financial configurations, and product specifications (e.g., container and/or visual information display specifications). The management website 215 is also connected to causes and benefactors 235, such as charities, for sending and receiving information and for exchanging value. The management website 215 is further connected 240 for sending and receiving information to advertising clients 245, where the advertising clients 245 can assign value to container and visual information display selections provided by the management website 215.

Connected 250 to the management website 215 is a for-profit entity or user 255 that assigns and distributes value based on information from the management website 215, where the value is used to cover the manufacture costs of the container and/or visual information display selected by the residential consumer 205. For example, based on the value derived from advertising clients, the for-profit entity 255 would cover the costs of manufacturing the containers and the waste and recycling infrastructure including operation of the collection vehicles. Therefore, in one way, the for-profit entity 255 can access the management website 215 to control value obtained by advertising clients to offset the collection infrastructure and processing of the collected waste and recyclables. In some cases, the for-profit entity 255 can derive value from the collected recyclable material by selling scrap metals, paper, and plastics. All or a portion of the value derived from the sale of the recyclable material may also be sent to the management website 215 to be dispensed according to selections by the residential consumer 205 (e.g., to particular causes or benefactors 235) and/or government program management 225. In some cases, the for-profit entity 255 may act as a program manager in conjunction with or in lieu of the government program management 225.

The for-profit entity 255 directs 260 the manufacture 265 of the container and/or visual information display which is then provided 270 to a shipping system 275. The shipping system 275 delivers 280 the container and/or visual information display to the residential consumer 205. For example, the shipping system 275 may include a collection vehicle that delivers the container and/or visual information display on a scheduled waste collection route.

Waste and recyclables from the residential consumer 205 are received 290 by a collection infrastructure 295, which may be connected (not shown) or part of the shipping 275 system. The collection infrastructure 295 includes a tracking system to record one or more various metrics that may include the amount and type of waste and recyclables received, the instances and duration of container use, display, and collection, the container location and type, and the identity of the visual information displayed. The infrastructure 295 uses one or more collection vehicles to receive 290 the waste and recyclables where the collection vehicle includes the various tracking functions. The data collected by the infrastructure 295 is communicated 300 to the management website 215. The management website 215 processes the data to distribute and/or receive value to or from one or more of the various parties, such as the causes and benefactors 235, the residential consumer 205, the advertising client 245, and the for-profit entity 255.

As one example, a residential consumer 205 accesses 210 the management website 215 to select a particular sized container and a removable advertising display. The management website 215 lists several container and display options provided 240 to the website by various advertising clients 245 and managed 220 and filtered by the government program management 225. The residential consumer 205 selects a particular advertisement for a home improvement retailer and a particular container and container color associated with the retailer. The home improvement retailer, as an advertising client 245, provides monetary value that is accounted by the management website 215 and a portion is channeled to the for-profit entity 255.

The for-profit entity 255 directs 260 the manufacture 265 of the selected container and visual information display. During manufacture, the container or the visual information display is embedded with a Radio Frequency IDentification chip (RFID) and the container is provided 270 to a recycling collection truck that is part of both the shipping 275 and collection infrastructure 295. The container is delivered 280 to the residential consumer 205. The container is used by the residential consumer store recyclable materials and is placed at the curbside of the consumer's residence on a weekly basis for collection. The container and accompanying visual information display is viewed by commuter and residential traffic typically at least on the scheduled collection day. The collection truck receives the recyclable material on the collection day each week and tracks the number of display instances, the identity of the visual information display, and the display location or address. Recording of display instances by the tracking system is accomplished using an automated RFID scanning device. The tracking information is then communicated 300 to the management website 215.

For example, if the collection truck and tracking system record that the residential consumer had the container at the curbside eight times over a two month period, the management website would draw value from the selected advertising client based on the eight tracked uses and displays of the advertisement. Consequently, value would be transferred from the advertising client to the charitable cause selected by the residential user. As one example, the eight display instances may have an associated value of five cents per instance, thereby transferring forty cents to the charitable cause. Additional monies could also be transferred to the for profit entity and/or government program management based on the tracked instances.

The present disclosure therefore provides methods and systems for ordering, designing, managing, tracking, and displaying visual information on waste and recycling containers, which are easy to use, universally functional, and versatile in operation. The present disclosure also provide methods and processes for ordering, designing, managing, tracking, and displaying visual information intended for targeted consumer viewing on trash and recycling containers.

The present methods and systems have one or more users. Users may include one or more entities which are to be advertised, also referred to herein as an advertiser, one or a multitude of end users, such as residential consumers, who implement the presentation and display of the advertisement of the advertiser, one or a multitude of containers of the type used in residential waste and recycling collection for storing, disposing, and transporting waste and recycling materials, one or a multitude of media and or information display advertisements, a container tracking and identification system, a main service and management website including computer software, internet web page based code, and methods of applications for providing both the advertiser and the end user with a method and process for ordering, selecting, designing, customizing, personalizing, managing, tracking, and displaying visual information intended for targeted consumer viewing on trash and recycling containers.

It is to be understood that the advertiser and or end user referred to herein may be an individual, business, charity, government agency, organization, corporation, as well as any other entity now referred to herein which can utilize and benefit from the present methods and systems.

Accordingly, the present methods and systems provide several benefits and advantages to the user. These include a way for an end user or consumer to interact with advertising or visual information content and a way for advertisers to reach consumers. The present disclosure allows end users to select and buy products and or services, manage their account, and network with other participating members by accessing a main service website (e.g., the management system) by means of electronic communications device such as desktop or laptop computing devices as well as hand held devices including mobile phone, Blackberry, Palm Pilot, Smart Phones, etc that have internet access capabilities. The user or an entity selected by the user may be compensated with rewards, credits, miles, money, coupons, points, etc, for each instance of advertising display. The end user may specify a charity, foundation, or other organization affiliation to receive value including compensation, funding, and or support. The end user or advertiser is provided with options and choices for displaying advertising or other information or visual content. Advertisers may display their advertising or other information or visual content to commuters. The end user may earn a continuous residual income from the display of advertising or other information or visual content. Members of a community are provided a means to give and selectively distribute monies back into their community. The end user or consumer can interact with the advertising or visual information content.

Various users may communicate with the management system or management website. Advertisers include global corporations, N.A. corporations, local businesses, small businesses, advertisement agencies, non-profits, and individual people. Government officials or authorities include condominium associations, county officials, city officials, and state officials. End users include residents in cities, suburbs, and rural areas. Waste collection and removal companies include city contracted or city owned and operated or private waste collection companies. Causes and benefactors include registered non-profit organizations and public charities, private foundations, schools, and churches.

The management system includes many forms, including website based systems. The management system allows an advertiser or an end user to access the main service website by means of a computer device such as a desktop, or laptop device or from a mobile communications device such as mobile or cellular phone, Blackberry, Palm Pilot, Smart Phones, etc that have internet access capabilities. From the main service website, the user will be able to access, configure, personalize, and otherwise manage all forms and aspects of information and data pertaining to their account including but not limited to, specify the type of advertisement as well as the brand, color, style, and or size of the container products, specify and manage the type of advertising program, charitable program or service, agency, charity, business, promotional event, sports team or other type of visual content to be associated with and displayed on the advertisement, as well as any other type of account information associated with the invention disclosed herein.

The management system website provides an environment where container owners, manufacturers, waste removal and management companies, consumers, businesses, communities, local governments, state and local agencies, and charities can meet, network, create alliances, manage, and establish business relationships based on and around the products and services offered by and through the main service website. The website allows for the development and implementation of programs such as Corporate Social Responsibility or CSR, green movement and social awareness, which serve as a means of receiving and or directing funds received from donations, product or services purchased, and/or charity allocations from products or services purchased, to the designated charity entity or other public or private foundation, agency, business, organization, or other entity or user.

The management system website will further provide a direct way for people or businesses to donate to specific or nonspecific entities. Consumers, residents, manufacturers, charities, foundations, waste removal companies, businesses, communities, local governments, and state and local agencies can register, join, or otherwise become a member of the main service website. Registered members have the ability to select, design, customized, personalize, purchase, or otherwise specify products and or services, and the charity or private foundation that they want associated with the products or services that they select.

The website further allows for the user or consumer to select the type and quantity of waste or recycling containers to order as well as allow them to select or assign one or a multitude of advertisers, sports teams, other information, charities, foundations, or other private entities to which all or a portion of the value or proceeds are to be allocated to, whereby the allocation parameters can be pre-defined and or assigned from the main service website program manager or other account management system such as a third party management system, to embody specific configurations and filters which can be modified, changed, or assigned by a registered account user. In some embodiments, end users and/or advertisers can easily access and manage their advertising campaigns and the beneficiaries of any value, such as proceeds or profits therefrom.

Some embodiments may also provide tax incentive programs from federal, state, and or local governments whereby advertisers, end users, consumers, residents, citizens, and or businesses may receive tax incentives to create advertising and charitable donation relationships.

End users may further customize their advertising or branding products and/or services whereby the end user can select one or a multitude of specific product, charity, sponsorships, promotional events, sport teams, other visual information (e.g., peace symbol) and or brand to display on their waste or recycling containers, as well as the duration for which the advertisements are to be displayed.

There are a variety of programs that can be implemented to provide the end user with both advertising displays and waste and or recycling containers. The advertising displays may be offered as aftermarket displays (e.g., units and/or/with mounts) that are applied to already existing and owned indoor/outdoor waste and recycling containers, whereby the user may specify, design, select, personalize, customize the type of advertising, charity, sports team, information they wish to receive and display.

In some embodiments of the invention, complete management of all alliances, relationships, and or business agreements may be entered into between the end user and all other entities as pertains to any and all advertising campaigns, promotional events, programs, products, services, distribution, allocation, and management of all funds, compensation, rewards, points, credits, and any other information.

In some embodiments, the present methods and systems utilize an internet based website to interact with and manage advertising content that is to be displayed on waste or recycling containers. These embodiments include computing devices and computer networks for controlling a variety of aspects related to the advertising or visual information content including display times, display intervals, frequency of display, and display location, as well as other similar features, functions or aspects.

The advertising or visual information content may be controlled from a fixed location by means of a wireless transmission to the various containers which are used to display the advertising or visual information content, or may be controlled from a remote or mobile location, such as from a vehicle which is independent of the advertising or visual information containers, which allows a user to manage the advertising or visual information content to be displayed, while in transit by means of wireless transmission over a wide region or area with common advertising or visual information content.

The website may provide various user services. Services for advertisers may include qualification, contracting, financial agreements, product specifications, advertiser user settings, product availability counter, display of corporate logo, and logo links to the advertiser's corporate website and/or social achievements. The website may include on-line reporting of consumer usage tracking reports, geographical product distribution reports, donation breakdown reports, ability to increase product availability, and can use secure and private access.

Program management, for example performed by a program manager or government entity, can include the following features. Management can include profiles for various users that include basic information and management preferences for the user or type of user. Online reporting may be used to generate a community participation report and community usage report.

The program management can include various filters, including censorship filters for the visual information. For example, the management may allow only particular types of industries or types of advertisers to participate. Filters or censorship may be applied to visual information provided from participating users or may be used select or limit particular users, including businesses, agencies, non-profits, churches, libraries, and schools. The number and types of advertisements (i.e., visual information) can be filtered with respect to brand, product, and promotional directives. For example, filters may be used to limit or prohibit visual information and/or advertisers relating to tobacco, liquor, casino, undergarment, beer, lottery, phone numbers, and firearms.

Program management can set user (e.g., residential consumer) settings regarding access to the management system. Login ID, account editing and deleting, and security are controlled by the program management. Security includes controlling visible information on the website. The program management can control participation options for users, where users may select pre-designed city and tax paid products, most popular sponsor paid products, or for example from the top 10 selected products, randomly selected product, or the user is presented with options to select, design and personalize a sponsor paid product.

Program management is used to configure the flow of value through the system or method. Value may relate to donations from non-profit contribution percentages or funds may be directed to or from other available governmental programs (e.g., education or schools). Value make take the form of various incentives, including miles, discounts, rewards, points, coupons, credits, and money.

Program management also directs the available user options in the management system (e.g., website). Product specifications for containers and/or visual information displays may be modified. For example, the program management may allow the user to select characteristics of the container, including whether the container is new or an existing container, style, size, shape, color, uses (e.g., waste, recyclables, yard waste), quantity, container options (e.g., plain, pre-designed or personalized), visual information display positioning on the container, ownership tracking type (e.g., address). The program management may allow the user to select characteristics of the visual information display including the choice of display placard, mount or unit, style, size, shape, color, background, reflective, weatherproof, interchangeable, and attachment. The program management may also allow selection of a usage tracking method including an embedded Radio Frequency IDentification chip (RFID), global positioning system (GPS), bar coding, and an electronic wireless transmitter such as a Bluetooth™-enabled device.

The program management allows the user to select sponsor donation funding selection options, such as directing funds to the city waste program, to a different city program (e.g., schools), or to 1/100 top charities, where for example, the charity logo may be displayed on the container or visual information display. For example, a user could direct a percentage of the value (e.g., 15%) of funds to 1/100 charities and the balance (e.g., 85%) to a non top 100 charity, a school, or a church.

The containers used in the present methods and systems include various waste and recycle containers. Containers include common waste or recycling containers used in residential waste collection that may be embodied in a variety of shapes, colors, and sizes, having an attached hinged lid or cover, detached removable lid or cover, or no lid or cover. The containers may also have attached wheels that allow for easy transport, or have no wheels. The container may further embody a separate rolling base that the container is placed into for transport. The container may also include features or hardware to accept or receive an advertisement display, or may also be embodied with a surface onto which an advertising display is fixably or removably attached. Additionally, the recycling containers may include rectangular shaped open top bins of varying sizes into which the recyclables are placed for collection.

The container and visual information display may be used in a variety of locations other than curbside waste or recycling containers, including any type of trash can or waste container that can be positioned or placed within the interior or exterior of a residential, commercial, private, public, or government environment where the containers may be viewable by people. These environments include schools, parks, shopping malls, sidewalks, libraries, sporting facilities, work places such as offices, transportation facilities such as airports, subways, bus stations, trains, train stations, amusement parks, museums, retail establishments, etc, wherein portable tracking devices and or wireless tracking systems may be used to monitor, track, or otherwise account for the location, display instances, advertising information, or other end user or advertiser account information or data not referred to herein.

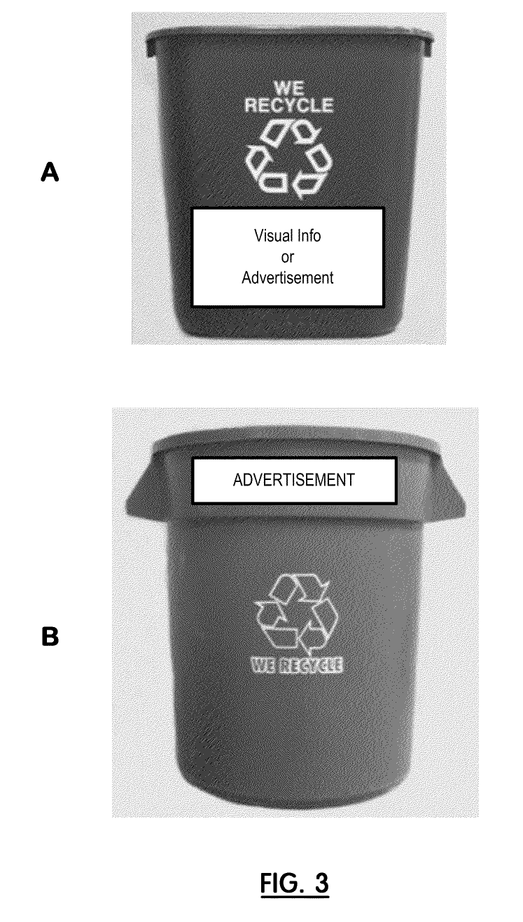

With reference to FIGS. 3A and 3B, examples of two embodiments of containers displaying visual information are shown.

The present methods and systems include many forms of visual information and displays for visual information used with one or more containers. For example, advertising displays can be pre-applied to new or existing containers that are not yet distributed to or owned by end users, whereby the containers may be given to the end user at reduced or no cost with user specified, designed, selected, personalized, customized advertising, charity, sports team, or other visual information content. The displays may be supplied by and paid for by the advertiser and given to the end user at no cost whereby a one time or periodic fee may be paid to the end user and or to the charity, foundation, or other entity at the end user's specification. The displays may also be supplied by and paid for by the advertiser and given to the end user at no cost in exchange for the end user receiving products and or services from the business or advertiser in the form of samples, discounts, coupons, rebate checks, rewards, or the like.

The advertising displays may be associated with a predetermined charity, foundation, or other association with value in the form of proceed allocations already established or as yet to be established quantities or values that may be based on a number of variables associated with the display such as location, duration of display, number of displays, number of views over a given duration or time frame. The advertising displays may further be associated with one or more programs that will earn value over a period of time based on a number of variables associated with the display or end user including location, duration of display, number of displays, number of views over a given duration or time, whereby the end user may earn money or rewards in the form of points, miles, credits, or other representation of value that will be connected to or associated with products or services that can be redeemed, purchased, or otherwise obtained for specific quantity or price. This type of rewards program may allow advertisers to ensure that the money or credit given to the end user for advertising displays will be spent on specific products or services offered by that specific business, company, or service provider.

The advertising display may further be incorporated into a “Pay Per Display” or “Pay Per Trip” program that compensates an end user or container owner for each day that each container is displayed for viewing. In this case, a user receives value for each ad on each container every time the container is displayed. The compensation associated with the “Pay Per Display” or “Pay Per Trip” program can be paid to the end user directly or may be allocated according to their direction or by management from the main service website account management page.

The advertising displays may be associated with and or sponsored by a wide variety of businesses, sports teams, educational institutions, product, brand, logo, affiliations of faith, state, local, or federal agencies, political parties, events, causes, non-profit organizations, and virtually any other entity that enters into a charitable, business, or sponsorship relationship through the main service website.

The advertising displays may be associated with and or sponsored by a program referred to herein as “Adopt a Bin”, whereby the waste containers and or advertising displays thereon can be paid for or sponsored by individuals, businesses, charities, government agencies, organizations, corporations or other entity not referred to herein.

It is to be understood that various methods for manufacturing the advertising displays may be used. Embodiments include a label made of inexpensive polymer material such as vinyl, paper, plastic, cloth, metal, or other similar suitable material including stock materials such as puffy, litho, latex, foil, thermal, and thermal transfer, whereon adhesive material is applied to the back surface of the label which thereby allows for adhesion to the waste or recycling container. The adhesive material may be embodied in a variety of types and forms including permanent, semi-permanent, removable, quick release, and others not referred to herein which will perform the same function and is to be considered apparent and obvious to the disclosure.

Other methods of attaching or affixing the advertising displays to the waste or recycling containers exist which may employ a variety of fasteners such as hook-and-loop (e.g., Velcro® fasteners), rivets, bolts, screws, ties, inter-locking components, or magnets, that do not alter the function or use of the invention and are to be considered apparent and obvious to the disclosure. Additionally, a specifically designed advertising display surface or mount may be embodied in the container body as a single embodiment whereon the advertising displays can be placed for viewing and then covered over, replaced, interchanged, or easily removed. The display may embody static adhesion for attaching advertising displays to containers.

The visual information display may comprise a frame component that is either adhered to or embodied in front, back, top, bottom, inside, and or side vertical surfaces of the waste or recycling container, and wherein a separate advertising display board or card may be inserted and secured into position. This allows for ease of insertion and removal of the advertising display board or card. The frame component may be affixed to and secured to the container in a variety of ways.

The present invention disclosed herein may comprise an advertising display component that is self-leveling by means of one or a multitude of weighted components built in or attached to the advertising display and which will ensure that the advertising display is always in the upright position regardless of the position of the container, which is optimal for clarity and recognition by a viewer.

The visual information display may also be embodied with reflective signage technology that allows for visibility during conditions of minimal or no sunlight, such as dusk or nighttime, by acting to reflect light such as that produced by vehicle headlights and thereby allowing a user to view the advertising display. The container or advertising display may further comprise signage that is presented in a variety of manner including but not limited in use to, bubbled, raised, embossed, or otherwise dimensionally protruding from the display surface. Additionally, the visual information may be embodied with a weather proofing or protective cover, shield, faceplate, or other protective surface that will act to protect the advertising display signage from the elements.

Another embodiment of the visual information comprises one or a multitude of LCD or liquid crystal display flat screen monitors disposed on the exterior rear, front, top, bottom, inside, or side vertical surfaces of the waste or recycling container, whereby the monitors will display advertising or other information or visual content including but not limited in use to, pre-recorded video ads, still image ads, and or live streaming video content or other forms of advertising not referred to herein which are to be considered apparent and obvious to the disclosure. The advertising content will be displayed for the purposes of being viewed by the public as the vehicle or pedestrian traffic passes in close proximity to the display. The advertiser can buy, order, or reserve advertising time in a traditional method of direct contact by phone, or by accessing the management system website whereby they can view available advertising time slots, order advertising time and or reserve advertising time, select the location or region in which the advertisements are to be displayed, upload advertising content for approval, and manage such content.

Advertising displays may be associated with and or sponsored by a wide variety of businesses, sports teams, educational institutions, product, brand, logo, affiliations of faith, state, local, or federal agencies, political parties, events, causes, non-profit organizations, and virtually any other entity that enters into a charitable, business, or sponsorship relationship through the main service website. Displays can be supplied by and paid for by the advertiser and given to the end user at no cost in exchange for the end user receiving products and or services from the business or advertiser in the form of samples, discounts, coupons, rebate checks, rewards etc. The visual information display allows for easy application, replacement, and removal of advertising content and or advertising or visual information display and a multitude of advertising displays may be used per container.

The present methods and systems include various tracking systems. Tracking the containers and displayed visual information is used to account for the number of times that a container is available for public viewing by detecting or scanning, either remotely or from a remote mobile vehicle such as a trash collection vehicle, when the container is at the curb in public view. The per display tracking information that is collected during the tracking process may also be utilized for the purposes of invoicing, crediting, billing, or otherwise incorporating the number of display for public viewing into the end user and or advertisers account for management.

The function of tracking each container and display for public viewing may be accomplished by using a variety of existing technologies including the use of Radio Frequency Identification technology or (RFID) which allows for the storing and remotely retrieving of data, whereby the advertising displays or the containers for waste or recycled materials will embody one component of the tracking system such as a tag or transponder that allow for the storage and retrieval of data in a remote manner, which will also allow for the tracking of individual advertising displays. The tracking may also be accomplished by means of Global Position System or (GPS) that will allow for the container to embody a receiver module which can be monitored remotely to determine the location of the container and then relay the information directly to a PC, desktop, or other computing device for management and tracking. Still another possible method of tracking which may be used is a bar code tracking system which utilizes individual bar code identifiers in conjunction with hand held scanners or bar code readers. Other systems or methods not referred to herein which may be used for tracking data such as location, date, time, end user information, advertiser information, weight of contents, number of times emptied, as well as other data or information, may also be used which perform the same purpose or function. In some embodiments, the tracking system is part of the waste collection infrastructure and may be mounted or utilized by a waste or recycling collection vehicle. Alternatively, separate tracking vehicles may be used to scan or track the number of instances that an advertisement display is presented for viewing.

The present methods and systems for advertising on waste or recycling containers provide several advantages and benefits. For example, advertisers such as individuals, businesses, charities, government agencies, organizations, corporations, as well as any other type of advertiser, can reach specific targeted markets based on demographics or location, including proximity to a location such as a business. The present methods and systems connect advertisers with residents, consumers, and businesses that are willing to display advertisements or other information pertaining to products, services, events, incentives, or other type of visual content, on their waste or recycling containers in order to provide incentives to recycle. Additional advantages include the ability for users to obtain Corporate Social Responsibility (CSR) recognition, have a positive environmental impact (e.g. escalate recycling awareness) and reduce waste tonnage, and improve the quality of life through directing value to charitable donations and funding recycling infrastructures.

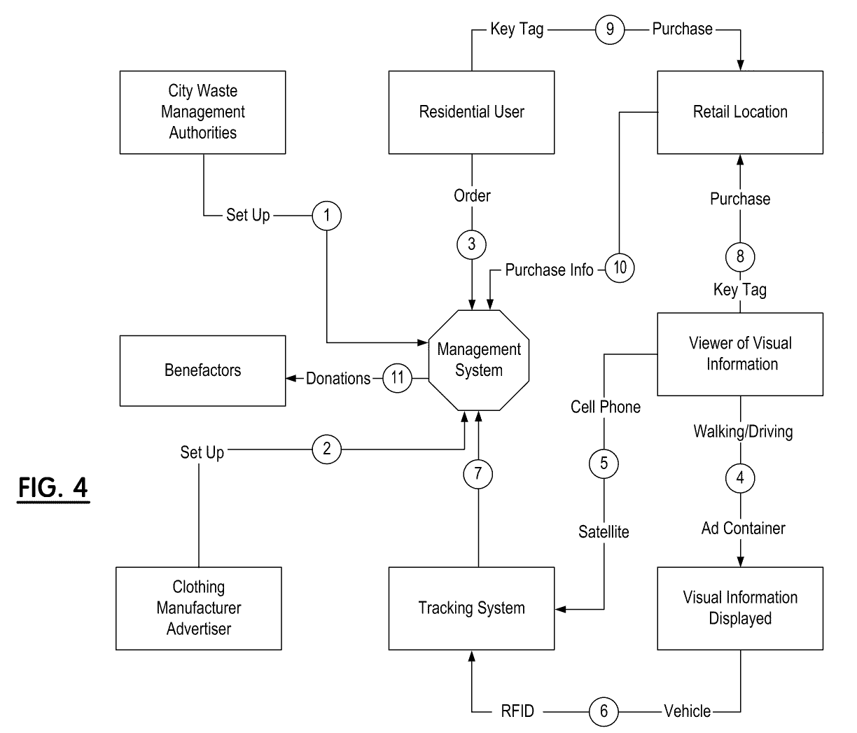

With reference to FIG. 4, a block diagram of one embodiment of a system for managing visual information illustrating interaction of a viewer with the system is shown. The viewer observes the container displaying the visual information while passing the container location. The viewer can register or acknowledge receipt of the visual information by using a cell phone or other device to communicate with the tracking system. Registration or acknowledgement of the visual information can allow the viewer to receive additional details relating to the visual information, such as product info, retailer locations, a coupon or discount, a pass code or key tag, or verification that the viewer encountered the displayed visual information. These additional details or verification can be transmitted to the viewer using various means, such as mail, electronic mail, wireless communication, or by cell phone, for example. In this way, the tracking system and management system can obtain metrics based on individual viewers and not limited to just the presence of the container and visual information as measured by waste or recycling collection. These metrics may include identity of the viewer, time, date, what visual information was viewed, including whether the viewer received the verification or utilized a coupon, discount, pass code, or key tag, or whether the viewer subsequently interacted with a retailer related to the visual information.

The system for managing visual information observable by a viewer can include the following components. An object displays visual information observable by the viewer and includes a tracking function. A mobile device operates to interact with the tracking function of the object and a tracking system operates to register interaction of the mobile device with the tracking function. A management system is included that has at least one rule governing interaction of the mobile device with the tracking function and operation of the tracking system, where the rule(s) operates to award a value based on interaction of the mobile device with the tracking function and the operation of the tracking system. A rewards entity receives the value awarded by the rule(s) of the management system and provides a return value to a user.

In some embodiments, the object displaying visual information observable by the viewer may be a recycling container having permanently affixed or removable signage and the visual information may be an advertising display. The object displaying visual information may also be an advertising sign, such as a billboard, and may include other media such as a newspaper, magazine, or flyer. In some cases, the object displaying visual information may be an electronic display, such as an LCD monitor or television, which may display one or more still or moving pictures, such as television commercials or trailers. Embodiments of visual information further include electronic displays that show an internet webpage or send/receive information from the internet. In some cases, the object displaying visual information may be vehicle, such as a passenger vehicle, commuter or freight train, or commercial vehicle such as a tractor trailer. The object displaying visual information may also be retail signage, such as found in front of a business.

These various objects displaying visual information include a tracking function, for example, that interacts with the mobile device. The tracking function may record that the viewer interacted with the visual information or was within a certain proximity of the visual information by using the mobile device. For example, the mobile device may include an RFID tag reader and may be operable to passively interact with an RFID tag embedded in the object that is acting as the tracking function of the object. In this case, the RFID tag reader may need only to be within a certain proximity of the object and RFID tag tracking function to obtain a signal that is sent to the tracking system via the mobile device. As another example, the tracking function of the object may be a bar code on or within the displayed visual information or object, where the bar code is scanned or imaged in some manner by the mobile device, or the tracking function may be an electronic wireless transmitter that can communicate with the mobile device, such as a Bluetooth™ device. Thus, the viewer may use the mobile device to actively interact with the tracking function of the object and associated visual information.

In some embodiments, the mobile device may be part of a recycling collection vehicle. In this manner, a recycling collection vehicle may collect recyclable material from a recycling container having a tracking function. The mobile device of the collection vehicle may passively and automatically communicate with the tracking system to register interaction of the mobile device with the tracking function in the recycling container. The user may therefore be a residential waste customer that is provided return value based on the rules of the management system and operation of the tracking system. For example, the residential user may receive return value from or for a rewards entity such as a retailer or manufacturer, based on the use, residential display, and waste collection event by the recycling collection vehicle, with the tracking system recording the interaction between the tracking function in the recycling container and the mobile device in the waste collection vehicle.

In some aspects, the user that is provided with return value from the rewards entity in the system may be the viewer. There may also be several rewards entities and the viewer of the visual information may receive return value from one or more of the rewards entities based on various passive and/or active interactions between the mobile device, tracking function of the object, and the tracking system.

The system may further comprise a managing entity that provides at least one rule to the managing system. For example, the managing entity may be a governmental entity, a commercial retailer or manufacturer, and/or benefactor. Likewise, the rewards entity may be a governmental entity, a commercial retailer or manufacturer, and/or benefactor. And in some cases the managing entity and the rewards entity may be the same entity. For example, where the visual information is an advertisement, the advertiser may be a managing entity that provides rules via the management system to determine the value awarded to the user based on interaction of the mobile device with the tracking function and the operation of the tracking system. The advertiser may also be the rewards entity that receives the value awarded by the rule(s) of the management system and provides a return value to the user. Where the user is the viewer of the advertisement, the viewer may receive a discount or the latest coupon for goods or services provided by the advertiser. In some embodiments, the return value provided to the user or viewer may include one or more of a monetary return, discount, coupon, credit, miles, and points.

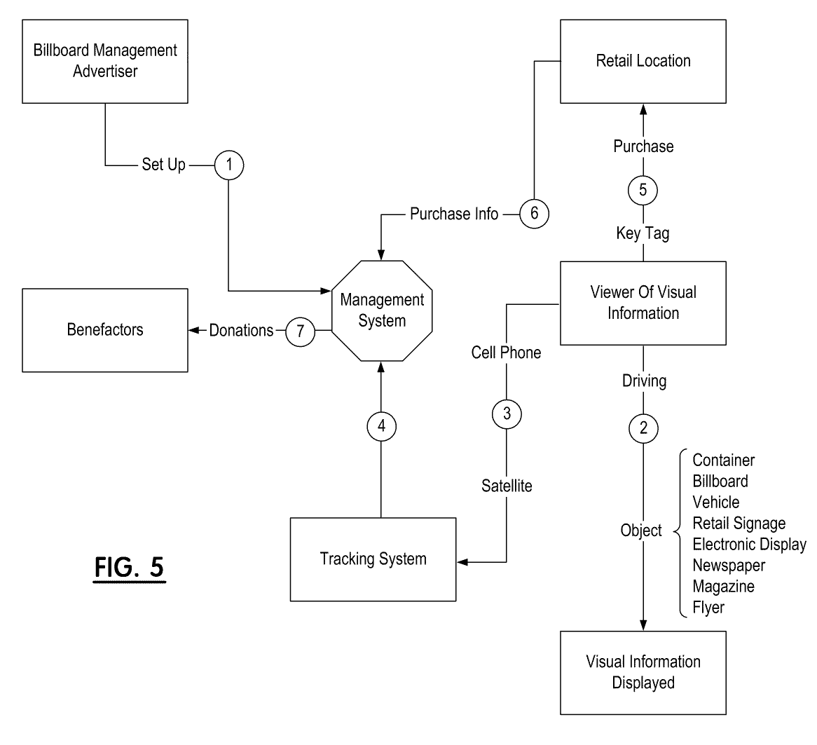

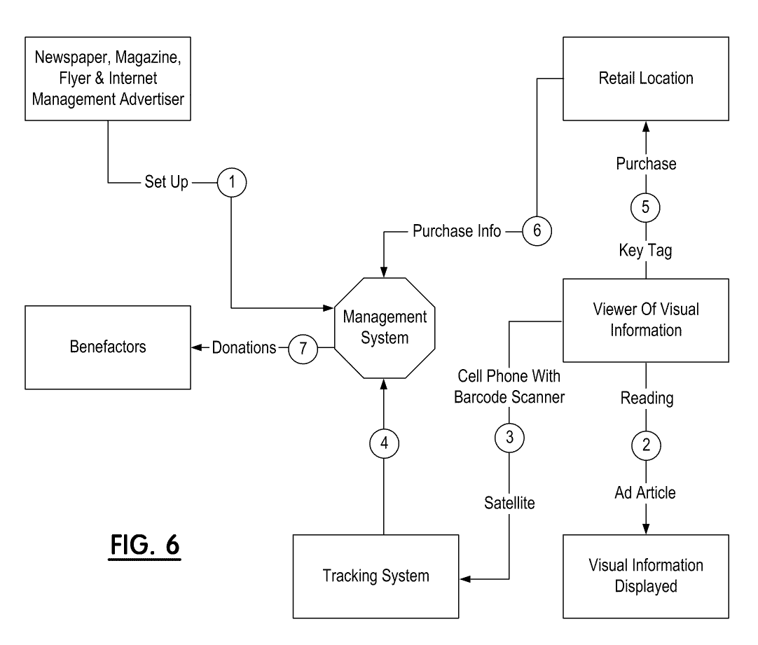

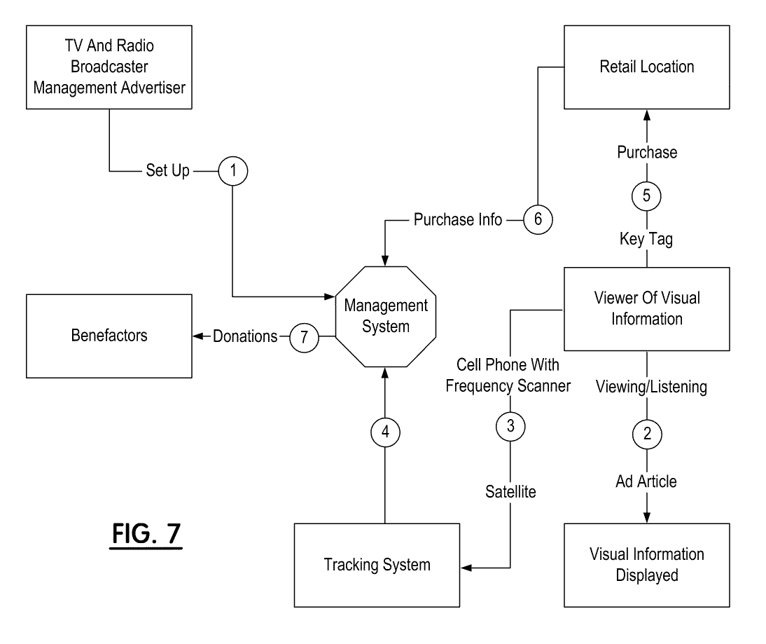

With reference to FIGS. 5, 6, and 7, block diagrams of three embodiments of systems for managing visual information that illustrate interaction with the viewer are shown. FIG. 5 illustrates where a viewer interacts with visual information in the form of a billboard. FIG. 6 illustrates where a viewer interacts with visual information in the form of printed material, such as a newspaper, magazine, flyer, or internet/online visual information. For example, instead of removing a perforated card from printed material, such a magazine, the viewer may transmit acknowledgement of viewing the information to the tracking system via a cell phone and subsequently receive verification or additional details relating to the visual information, such as product info, retailer locations, a coupon or discount, a pass code or key tag. FIG. 7 illustrates where a viewer interacts with audio or visual information in the form of radio or television.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for managing visual information observable by a viewer, comprising:
an object displaying visual information observable by the viewer and including a tracking function;
a mobile device operable to interact with the tracking function of the object;
a tracking system operable to register interaction of the mobile device with the tracking function;
a management system including at least one rule governing interaction of the mobile device with the tracking function and operation of the tracking system, the rule operable to award a value based on interaction of the mobile device with the tracking function and operation of the tracking system; and
a rewards entity that receives the value awarded by the rule of the management system and provides a return value to a user.

2. The system of claim 1, wherein the object displaying visual information observable by the viewer is a recycling container.

3. The system of claim 2, wherein the mobile device is comprised by a recycling collection vehicle.

4. The system of claim 3, wherein the user is a residential waste customer.

5. The system of claim 1, wherein the user is the viewer.

6. The system of claim 1, wherein the mobile device is a cell phone.

7. The system of claim 1, wherein the tracking function is an RFID tag, bar code, or electronic wireless transmitter.

8. The system of claim 1, wherein the mobile device is operable to passively interact with the tracking function of the object.

9. The system of claim 1, wherein the mobile device is operable to actively interact with the tracking function of the object via action of the viewer.

10. The system of claim 1, wherein the rewards entity that receives the value awarded by the rule of the management system and provides a return value to the viewer is a member of the group consisting of a governmental entity, a commercial retailer or manufacturer, a benefactor, and combinations thereof.

11. The system of claim 1, wherein the return value to the viewer provided by the rewards entity is a monetary return, discount, coupon, credit, miles, or points.

12. The system of claim 1, further comprising a managing entity that provides at least one rule to the managing system, where the managing entity is selected from the group consisting of a governmental entity, a commercial retailer or manufacturer, a benefactor, and combinations thereof.

13. The system of claim 12, wherein the managing entity and the rewards entity are the same.

14. The system of claim 1, wherein the object displaying visual information observable by the viewer and including a tracking function is a container, billboard, vehicle, retail signage, electronic display, newspaper, magazine, or flyer.

15. A system for managing visual information observable by a viewer, comprising:
a recycling container displaying visual information observable by the viewer;
a recycling collection vehicle comprising a mobile device operable to interact with the visual information;
a tracking system operable to register interaction of the mobile device with the visual information;
a management system including at least one rule governing interaction of the mobile device with the tracking function and operation of the tracking system, the rule operable to award a value based on interaction of the mobile device with the tracking function and operation of the tracking system;
a rewards entity that accepts the value awarded by the rules of the management system and provides a return value to the viewer; and
a managing entity that provides at least one rule to the managing system, where the managing entity is selected from the group consisting of a governmental entity, a commercial retailer or manufacturer, a benefactor, and combinations thereof.
